(19) United States
(12) Patent Application Publication
(10) Pub. No.: US 2015/0032407 A1
(43) Pub. Date: Jan. 29, 2015

(54) FALLING STATE DETERMINATION FOR DATA STORAGE DEVICE

(71) Applicant: Western Digital Technologies, Inc., Irvine, CA (US)

(72) Inventors: MICHAEL T. NICHOLLS, LAGUNA HILLS, CA (US); HIEN T. CHU, FOUNTAIN VALLEY, CA (US)

(73) Assignee: Western Digital Technologies, Inc., Irvine, CA (US)

(21) Appl. No.: 14/033,048

(22) Filed: Sep. 20, 2013

Related U.S. Application Data
(60) Provisional application No. 61/857,449, filed on Jul. 23, 2013.

(51) Int. Cl. G01P 15/00

(52) U.S. Cl. CPC G01P 15/00
USPC 702/141

(57) ABSTRACT

Determination of when an electronic device such as a data storage device (DSD) is falling. An input is received indicating an acceleration of the electronic device during a time period. A classifier function is calculated using the input and it is determined whether the electronic device is falling based on a calculated value of the classifier function. During a calibration process, acceleration values are recorded representing a plurality of actual falls and a plurality of false falls of the electronic device. Weight values are set for a weighted classifier function using the recorded acceleration values and the weighted classifier function is stored in a memory of the electronic device.

### CROSS-REFERENCE TO RELATED APPLICATION

This application claims the benefit of U.S. Provisional Application No. 61/857,449 (Atty. Docket No. T6526.P), filed on Jul. 23, 2013, which is hereby incorporated by reference in its entirety.

### BACKGROUND

Data storage devices (DSDs) are often used by electronic devices to record data onto or to reproduce data from a recording media. As electronic devices become increasingly mobile, the risk of mechanical shock to a DSD increases from events such as when the electronic device is dropped. In order to prevent damage to the DSD, some DSDs may take precautionary action before impact if it is sensed that the electronic device or DSD is falling. In the example of a DSD including a rotating magnetic disk as a recording media, a magnetic head may be moved away from the disk during a fall to prevent contact between the head and the disk at impact after the fall. Such contact between the head and the disk may result in damage to the disk and loss of data stored on the disk.

The increasing mobility and increasing physical movement of electronic devices such as tablet computers have also made it more difficult to accurately determine when a DSD is in a falling state as opposed to some other type of motion which might provide a false indication of falling. A false indication of falling may, for example, result from walking or running with the electronic device or may result from movement of the electronic device as part of a particular application such as gaming. False indications of falling can degrade performance of the electronic device due to unnecessary preventative measures taken by the DSD such as moving a head away from a disk during a false fall. On the other hand, the failure to take precautionary measures during an actual fall can result in severely damaging the DSD and/or losing data.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed. Reference numbers are reused throughout the drawings to indicate correspondence between referenced elements.

FIG. 1 is a block diagram depicting a data storage device (DSD) according to an embodiment.

FIG. 2 is a flowchart for a fall determination process according to an embodiment.

FIG. 3 is a flowchart for a calibration process for fall determination according to an embodiment.

FIG. 4 is a graph depicting a logistic function used in the calibration process of FIG. 3.

FIG. 5 illustrates test results for fall determination according to an embodiment.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

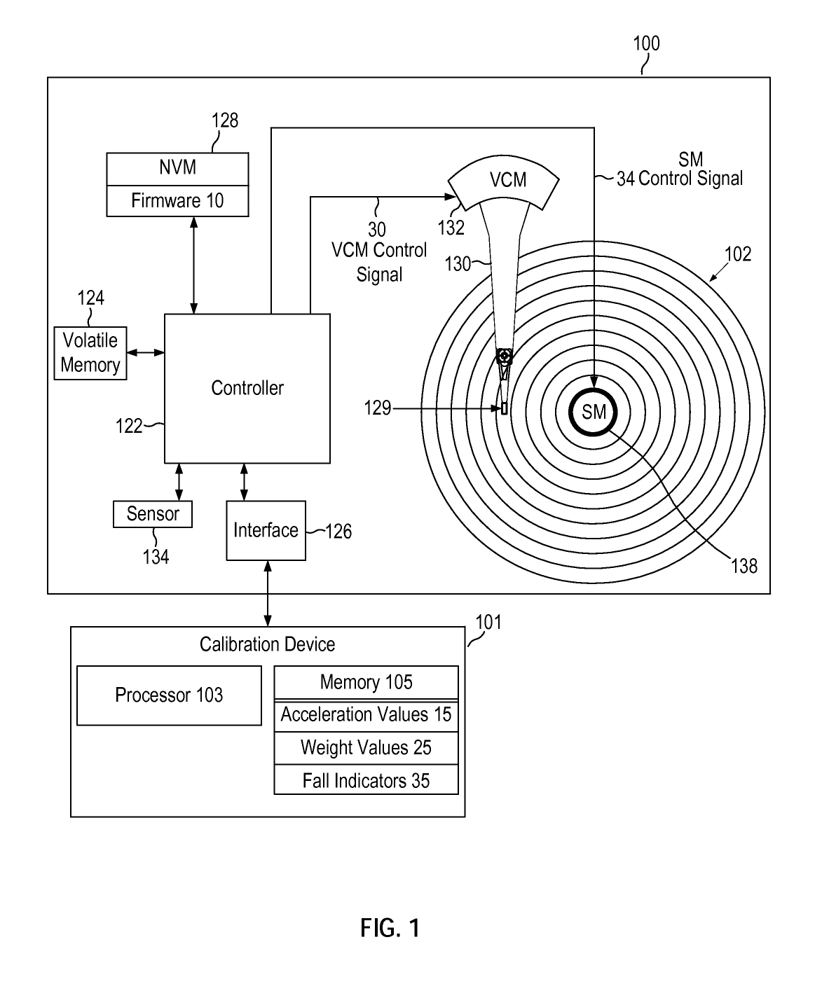

FIG. 1 illustrates a block diagram of data storage device (DSD) 100 in communication with calibration device 101 according to one example embodiment. DSD 100 can be or form part of an electronic device such as a computer system (e.g., desktop, mobile/laptop, tablet, smartphone, etc.) or other electronic device such as a digital video recorder (DVR). In one embodiment, calibration device 101 can be used during a manufacturing process of DSD 100 for testing or programming firmware 10 of DSD 100. Those of ordinary skill in the art will appreciate that DSD 100 and calibration device 101 can include more or less than those elements shown in FIG. 1.

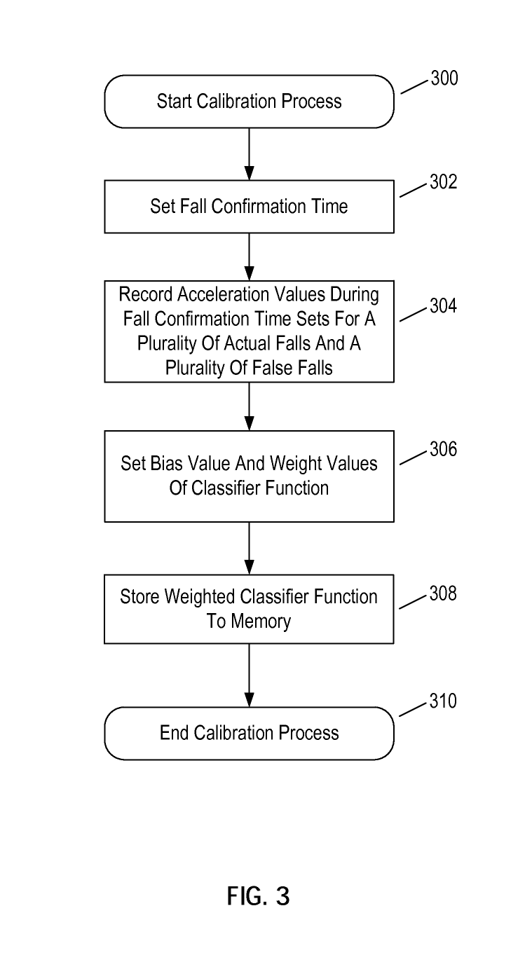

As shown in FIG. 1, calibration device 101 includes memory 105 and processor 103 which can perform a calibration process for fall determination such as the process described below with reference to FIG. 3. Processor 103 can be implemented using one or more processors for executing instructions and can include a microcontroller, a Digital Signal Processor (DSP), an Application Specific Integrated Circuit (ASIC), a Field Programmable Gate Array (FPGA), hard-wired logic, analog circuitry and/or a combination thereof. Memory 105 can include a volatile and/or a non-volatile memory for storing data. In the example of FIG. 1, memory 105 stores acceleration values 15, weight values 25, and fall indicators 35 for calibrating the fall determination process of DSD 100.

In one embodiment, DSD 100 includes controller 122 which can perform a fall determination process as described herein. Controller 122 can be implemented using one or more processors for executing instructions and can include a microcontroller, a Digital Signal Processor (DSP), an Application Specific Integrated Circuit (ASIC), a Field Programmable Gate Array (FPGA), hard-wired logic, analog circuitry and/or a combination thereof.

In the example of FIG. 1, DSD 100 includes rotating magnetic disk 102 and head 129 connected to the distal end of actuator 130 which is rotated by voice coil motor (VCM) 132 to position head 129 over disk 102. Head 129 includes at least a read element (not shown) for reading data from disk 102, and a write element (not shown) for writing data on disk 102.

Disk 102 comprises a number of radial spaced, concentric tracks for storing data and can form part of a disk pack (not shown) which can include additional disks below disk 102.

With reference to FIG. 1, DSD 100 may also optionally include solid-state non-volatile memory (NVM) 128 for storing data, for example, for use as a cache or as part of a solid state hybrid drive (SSHD) implementation of DSD 100. NVM 128 stores firmware 10 which can include computer-readable instructions used by DSD 100 to implement the fall determination process described below.

While the description herein refers to solid-state NVM generally, it is understood that solid-state memory may comprise one or more of various types of memory devices such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof.

Volatile memory 124 can include, for example, a DRAM. Data stored in volatile memory 124 can include data read from disk 102, data to be written to disk 102, and/or instructions for DSD 100, such as instructions loaded into volatile memory 124 from firmware 10.

Interface 126 is configured to interface DSD 100 with calibration device 101 and may interface according to a standard such as, for example, PCI express (PCIe), serial advanced technology attachment (SATA), or serial attached SCSI (SAS). As will be appreciated by those of ordinary skill in the art, interface 126 can be included as part of controller 122. Although FIG. 1 depicts the co-location of calibration device 101 and DSD 100, in other embodiments the two need not be physically co-located. In such embodiments, DSD 100 may be located remotely from calibration device 101 and connected to calibration device 101 via a network interface. When DSD 100 is not being calibrated, calibration device 101 may be disconnected from DSD 100.

DSD 100 also includes spindle motor (SM) 138 for rotating disk 102 when writing data to disk 102 or reading data from disk 102. SM 138 and VCM 132 are connected to controller 122 which includes control circuitry such as a servo controller to control SM 138 and VCM 132 with VCM control signal 30 and SM control signal 34, respectively. These control signals can be, for example, control currents for controlling the rotation of VCM 132 and SM 138.

Sensor 134 is configured to detect acceleration of DSD 100 and can include, for example, an XYZ sensor with three degrees of freedom. In other embodiments, sensor 134 can include a sensor with six degrees of freedom such as an XYZ-YPR sensor. The detected acceleration can be input to controller 122 to determine when DSD 100 is in a falling state. For example, sensor 134 may detect that DSD 100 is in a free-fall state or that DSD 100 is in a tipping-drop state where DSD 100 rotates about an axis while at least a portion of DSD 100 drops. Controller 122 may then implement protective measures to prevent damage to DSD 100 before impact. In particular, controller 122 can control VCM 132 via VCM control signal 30 to move head 129 away from disk 102 in an attempt to avoid contact between head 129 and disk 102 during an impact. Contact between head 129 and disk 102 can result in damage to disk 102 and loss of data stored on disk 102.

In other embodiments, sensor 134 may be part of a host (not shown) in communication with DSD 100 and located in the same device as DSD 100. In such embodiments, the input of sensor 134 may be received by controller 122 via interface 126.

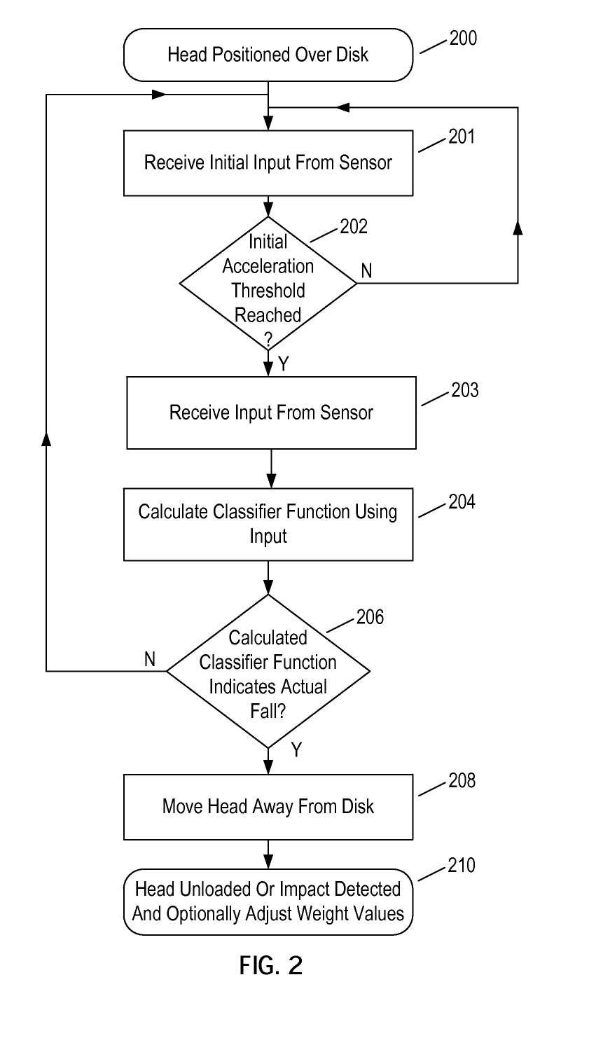

FIG. 2 is a flowchart for a fall determination process which can be performed by controller 122 during operation of DSD 100 according to one embodiment. The process begins in block 200 when head 129 is positioned over disk 102. During normal operation, head 129 floats over the surface of disk 102 due to airflow between head 129 and the surface of disk 102. This airflow is generated by the spinning of disk 102 by SM 138. As noted above, contact between disk 102 and head 129 can damage disk 102 and result in data lost from disk 102. To protect against such damage and data loss, controller 122 moves head 129 away from disk 102 when a fall is detected. However, such movement of head 129 when DSD 100 is not actually falling can cause a decrease in performance of DSD 100 due to the interruption of normal operation of DSD 100. Accordingly, the fall determination process of FIG. 2 seeks to differentiate between actual falls and false falls detected by sensor 134.

In block 201, an initial input is received by controller 122 from sensor 134 indicating an acceleration of DSD 100 during an initial time period. In one implementation, the input from sensor 134 may include a series of acceleration values for each dimension detected by sensor 134 every 1 ms over an initial time period of 15 ms. In the case where sensor 134 is a three axis XYZ sensor, the input received in block 201 can include acceleration values in each of an x dimension, y dimension and z dimension during the initial time period.

In block 202, controller 122 of DSD 100 determines whether an initial acceleration threshold has been reached by the initial input received in block 201. The initial acceleration threshold may be an acceleration set for each of the dimensions detected by sensor 134. For example, in an implementation where sensor 134 is an XYZ sensor, the initial acceleration threshold may be a value of 0.6 times the gravitational acceleration constant G in each of the three dimensions detected by sensor 134. In other embodiments, the initial acceleration threshold may be reached when sensor 134 has detected accelerations of less than or equal to 0.6 G in each of the measured dimensions for the entirety of the initial time period. If the initial acceleration threshold has not been reached in block 202, the process returns to block 201 to receive another initial input from sensor 134.

If the initial acceleration threshold has been reached in block 202, this can trigger controller 122 to receive another input from sensor 134 in block 203 indicating an acceleration of DSD 100 during a time period following the initial time period. As discussed in more detail below, evaluation of the input by controller 122 can serve as an attempt to confirm that the trigger caused by reaching the initial acceleration threshold in block 202 indicates an actual falling state.

The second period of time may be longer than the initial period of time and can be based on a safe fall time for DSD 100 where a fall time longer than the safe fall time is more likely to result in damage to DSD 100. For example, DSD 100 may be able to withstand a fall from a height of 8.6 cm in most situations without damage. The second period of time may then be set based on a corresponding fall time of 132 ms for a height of 8.6 cm. In this example, the second period of time may be set to 40 ms to allow for 15 ms to determine whether the initial acceleration threshold has been reached in block 202, to allow for a park time of 60 ms to move head 129 away from disk 102, and to allow for a margin of safety of 17 ms before impact at 132 ms or more. By setting the second period of time in this way, it is ordinarily possible to reduce the likelihood of damage to DSD 100 since there should be enough time to confirm an actual fall and move head 129 away from disk 102 before an impact resulting from a fall that could damage DSD 100. Of course, in other embodiments the second period of time can be set differently to meet different design criteria.

In block 204, controller 122 calculates a classifier function using the input received from sensor 134 in block 203. The classifier function can serve as a binary classifier to determine whether DSD 100 is in an actual fall state or if DSD 100 is experiencing a motion similar to falling in a false fall state. In one embodiment, the classifier function can generally be expressed as shown in Equation 1 below to provide a binary classification of an actual fall or a false fall.

c=f(x₁ . . . xₙ,y₁ . . . yₙ,z₁ . . . zₙ) Eq. 1

c≧0, actual fall

c<0, false fall

In Equation 1, x₁ . . . xₙ can represent accelerations detected by sensor 134 in an x dimension during samplings from time 1 to time n (e.g., 1 ms to 40 ms). Similarly, y₁ . . . yₙ can represent accelerations detected by sensor 134 in a y dimension from time 1 to time n, and z₁ . . . zₙ can represent accelerations detected by sensor 134 in a z dimension from time 1 to time n. The values for these accelerations can be temporarily stored by controller 122 in volatile memory 124, for example. The calculated value of the classifier function can then be used by controller 122 to determine whether DSD 100 is actually falling.

In one embodiment, the classifier function may take the form of a function including a weighted sum of values derived from the input, such as:

c=w₀+Σⁿᵢ₋₁w_{xy,i}xᵢyᵢ+w_{xz,i}xᵢzᵢ+w_{yz,i}yᵢzᵢ+wₓ_{²}_{,i}xᵢ²+w_{y}_{²}_{,i}yᵢ²+w_{z}_{²}_{,i}zᵢ² Eq. 2

where w₀, w_{xy}, w_{xz}, w_{yz}, wₓ_{²}, w_{y}_{²}, and w_{z}_{²} are weight values set by a calibration process such as the calibration process of FIG. 3. The squares of the acceleration values x₁, y₁ and Z₁ can reduce the effect of directional dependence during a falling state so that a calculated value of the classifier function is less dependent on the direction in which DSD 100 is falling. In another embodiment, the classifier function may include the absolute value of the acceleration values for xᵢ, yᵢ and zᵢ to decrease directional dependence as shown in Equation 3 below.

c=w₀+Σⁿᵢ₌₁w_{xy,i}|xᵢ∥yᵢ|+w_{xz,i}|xᵢ∥zᵢ|+w_{yz,i}|xᵢ∥zᵢ|+wₓ_{²}_{,i}xᵢ²+w_{y}_{²}_{,i}yᵢ²+w_{z}_{²}_{,i}zᵢ² Eq. 3

With reference to FIG. 2, controller 122 determines in block 206 whether the calculated value of the classifier function (e.g., the calculated value of Equations 1, 2 or 3) indicates an actual fall. In the example of Equation 1, a calculated value greater than or equal to 0 would indicate an actual fall and a calculated value of less than 0 would indicate a false fall.

If the calculated value does not indicate an actual fall, the process returns to block 201 to receive another initial input from sensor 134 during another initial time period. On the other hand, if the calculated value of the classifier function indicates an actual fall in block 206, controller 122 controls VCM 132 via VCM control signal 30 to move head 129 away from disk 102 as a protective action against an impending mechanical shock event.

The fall determination process of FIG. 2 then ends in block 210 when an impact has been detected by sensor 134 or head 129 has been unloaded (e.g., parked on a head unloading ramp) from disk 102. In addition, the weight values of the classifier function can be optionally adjusted during operation of DSD 100 as part of a field calibration process. In this regard, controller 122 in block 210 may adjust the weight values of the classifier function using the input received in block 203 and the determination that DSD 100 has experienced an actual fall.

In other embodiments, blocks 201 and 202 of FIG. 2 may be omitted so that the classifier function is continually evaluated for inputs received from sensor 134 without first determining whether an initial acceleration threshold has been reached in block 202. Although blocks 201 and 202 generally allow for less computations since the classifier function is not continually calculated in block 204, omitting blocks 201 and 202 may allow for a quicker determination of an actual fall by not having to collect an initial input from sensor 134 and compare it to an initial acceleration threshold in block 202.

FIG. 3 is a flowchart for an offline calibration process for setting the weighting of a classifier function according to one embodiment. The calibration process of FIG. 3 may be performed as part of a manufacturing or test process for DSD 100 and can be performed by calibration device 101.

In block 300, the calibration process begins and the period of time for an acceleration input (e.g., the input received in block 203 of FIG. 2) is set by calibration device 101 in block 302. As discussed above with reference to FIG. 2, the period of time can be set based on a specified fall time for a given height. In other embodiments, an initial period of time for an initial input (e.g., the initial input received in block 201 of FIG. 2) may also be set in block 302.

In block 304, acceleration values are recorded for a plurality of actual falls and a plurality of false falls. These values may be detected by sensor 134 in DSD 100 and stored in memory 105 of calibration device 101 as acceleration values 15. In this regard, the test falls may be performed by dropping DSD 100 or an electronic device including DSD 100 from different heights and/or with different rotations with calibration device 101 connected or disconnected from DSD 100. In addition, the iterative testing of actual and false falls in block 304 may be performed with different DSDs of the same design in situations where damage may affect the detection or quality of acceleration values.

In block 306, processor 103 of calibration device 101 sets a bias value (i.e., w₀) if needed and minimizes (i.e., mathematically reduces) a cost function using acceleration values 15 to set weight values (e.g., w_{xy}, w_{xz}, w_{yz}, wₓ_{²}, w_{y}_{²}, and w_{z}_{²} in Equations 2 or 3 above) of the classifier function. The cost function is formulated to reduce the misclassification of actual falls and false falls. In this regard, the cost function can be based off of an error of the calculated value of the classifier function. One such cost function is shown below as Equation 4.

c(w)=error² Eq. 4

In addition, a logistic function can be used to approximate a step function to set a particular value of the classifier function (e.g., c=0 in the example of Equation 1 above) as the dividing line between actual falls and false falls. An example of such a logistic function is:

$$l ( c ) = \frac{1}{1 + {e}^{- c}} \qquad Eq . 5$$

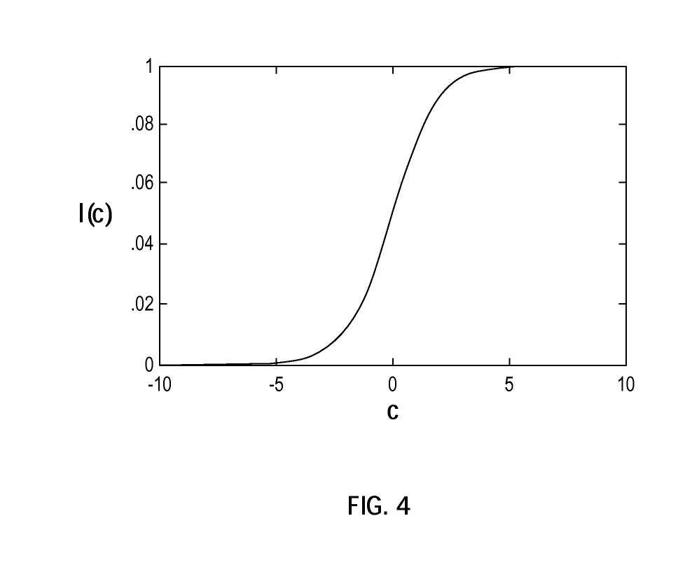

which is graphed in FIG. 4 where the transition from l(c)=0 (false fall) to l(c)=1 (actual fall) is centered at c=0. In other words, the logistic function of Equation 5 is formulated so that calculated values of the classifier function will indicate a false fall when c<0 and will indicate a real fall with calculated values of c>0. Using the logistic function of Equation 5, the error in Equation 4 can be represented as:

$$error = r - \frac{1}{1 + {e}^{- c}} \qquad Eq . 6$$

where the result, r, is equal to one for actual falls and equal to zero for false falls.

The recorded acceleration values 15 can then be used to calculate classifier function values c for the plurality of actual falls and the plurality of false falls. In this regard, the fall indicators 35 can be used to relate sets of acceleration values in acceleration values 15 to either actual falls or false falls and for setting the value for r accordingly.

Returning to FIG. 3, the cost function of Equation 4 can be minimized in block 306 using a method such as gradient descent to solve for the weight values using Equation 7 below.

wₙ₊₁=wₙ+a·error·lₙ·(1−lₙ)·s Eq. 7

where s is a particular set of acceleration values from acceleration values 15 corresponding to either an actual fall or a false fall, and a is an optional coefficient for weighting actual falls more heavily than false falls. For example, a can be set to a higher value such as a=2 for sets of acceleration values for actual falls than for sets of acceleration values for false falls which may have a=1.

Actual falls may be weighted more heavily during the calibration process to reduce the misclassification of actual falls as false falls at a cost of possibly misclassifying some false falls as actual falls during operation of DSD 100. In other words, the possible damage to DSD 100 due to misclassifying an actual fall can be less of a penalty than a temporary loss in performance due to misclassifying a false fall as an actual fall. The choice of classifying actual falls with c≧0 rather than simply c>0 in Equation 1 above can also reflect this preference for more accurate determination of actual falls.

In block 308, the set weight values can be stored in memory 105 of calibration device 101 as weight values 25. The weight values are then used to write the weighted classifier function as part of firmware 10 of DSD 100 for use during operation of DSD 100. The calibration process of FIG. 3 then ends in block 310.

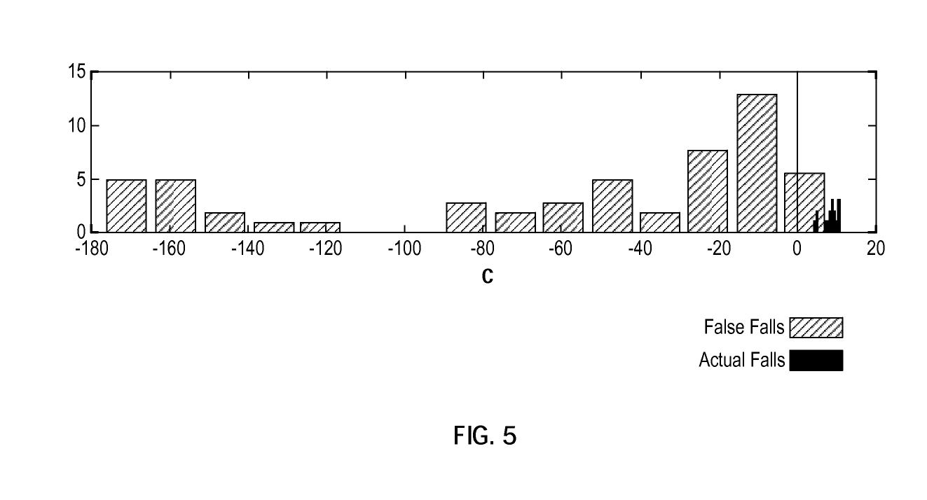

FIG. 5 illustrates test results for a fall determination process such as the fall determination process of FIG. 2 after setting the weighting of a classifier function as in the example of FIG. 3. As shown in FIG. 5, the smaller solid bars to the right of a zero classifier function value c indicate instances of actual falls. The thicker cross-hatched bars in FIG. 5 indicate instances of false falls. In this test, 96.4% of the false falls were correctly determined with a calculated value for c of less than zero. Specifically, 54 false falls were correctly determined as false falls and two false falls were incorrectly determined as actual falls as indicated by the overlap of the thick cross-hatched bar past the zero line for c.

Moreover, 100% of the actual falls (19 out of 19 actual falls) were correctly determined with a calculated value of c greater than zero. Thus, by using a classification function as disclosed herein, it is ordinarily possible to accurately differentiate between actual falls and false falls.

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes a processor or computer to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, and controllers described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The activities of a method or process described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC).

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive and the scope of the disclosure is, therefore, indicated by the following claims rather than by the foregoing description. All changes which come within the meaning and range of equivalency of the claims are to be embraced within their scope.

What is claimed is:

1. A data storage device (DSD) comprising:
a memory for storing data; and
a controller configured to:
receive an input indicating an acceleration of the DSD during a time period;
calculate a classifier function using the input; and
determine whether the DSD is falling based on a calculated value of the classifier function.

2. The DSD of claim 1, wherein the classifier function includes a weighted summation of values derived from the input.

3. The DSD of claim 2, wherein the weighting of the classifier function is set as part of a manufacturing process of the DSD.

4. The DSD of claim 2, wherein the controller is further configured to adjust the weighting of the classifier function during operation of the DSD.

5. The DSD of claim 2, wherein the classifier function is weighted so as to improve an accuracy of actual fall determination over an accuracy of false fall determination.

6. The DSD of claim 2, wherein the weighting of the classifier function is determined by minimizing a cost function for inputs representing actual falls and false falls of the DSD.

7. The DSD of claim 6, wherein the cost function includes a logistic function.

8. The DSD of claim 1, wherein the input includes a series of acceleration values for an acceleration of the DSD detected during the time period.

9. The DSD of claim 8, wherein the controller is further configured to calculate the classifier function using absolute values of the acceleration values in the series of acceleration values.

10. The DSD of claim 8, wherein the controller is further configured to calculate the classifier function using squares of the acceleration values in the series of acceleration values.

11. The DSD of claim 1, wherein the controller is further configured to:
receive an initial input indicating an acceleration of the DSD during an initial time period before the time period; and
determine whether the initial input has reached an initial acceleration threshold before calculating the classifier function.

12. The DSD of claim 11, wherein the initial acceleration threshold is based on a proportion of a gravitational acceleration constant.

13. The DSD of claim 11, wherein the initial input includes an initial series of acceleration values for an acceleration of the DSD detected during the initial time period, and wherein the controller is further configured to determine that the initial input has reached the initial acceleration threshold when each of the acceleration values in the initial series of acceleration values is less than or equal to the initial acceleration threshold.

14. The DSD of claim 1, wherein the time period is based on a safe fall time corresponding to a reduced likelihood of damage to the DSD for falls lasting less than the safe fall time as compared to falls lasting longer than the safe fall time.

15. The DSD of claim 1, further comprising a sensor for detecting acceleration of the DSD and providing the input.

16. A method for determining when an electronic device is falling, the method comprising:
receiving an input indicating an acceleration of the electronic device during a time period;
calculating a classifier function using the input; and
determining whether the electronic device is falling based on a calculated value of the classifier function.

17. The method of claim 16, wherein the classifier function includes a weighted summation of values derived from the input.

18. The method of claim 17, further comprising adjusting the weighting of the classifier function during operation of the electronic device.

19. The method of claim 16, wherein the input includes a series of acceleration values for an acceleration of the electronic device detected during the time period.

20. The method of claim 19, further comprising calculating the classifier function using absolute values of the acceleration values in the series of acceleration values.

21. The method of claim 19, further comprising calculating the classifier function using squares of the acceleration values in the series of acceleration values.

22. The method of claim 16, further comprising:
receiving an initial input indicating an acceleration of the electronic device during an initial time period before the time period; and
determining whether the initial input has reached an initial acceleration threshold before calculating the classifier function.

23. The method of claim 22, wherein the initial acceleration threshold is based on a proportion of a gravitational acceleration constant.

24. The method of claim 22, wherein the initial input includes an initial series of acceleration values for an acceleration of the electronic device detected during the initial time period.

25. The method of claim 24, further comprising determining that the initial input has reached the initial acceleration threshold when each of the acceleration values in the initial series of acceleration values is less than or equal to the initial acceleration threshold.

26. The method of claim 16, wherein the time period is based on a safe fall time corresponding to a reduced likelihood of damage to the electronic device for falls lasting less than the safe fall time as compared to falls lasting longer than the safe fall time.

27. A method for calibrating an electronic device for determining when the electronic device is falling, the method comprising:
recording acceleration values representing a plurality of actual falls and a plurality of false falls of the electronic device;
setting weight values for a weighted classifier function using the recorded acceleration values; and
storing the weighted classifier function in a memory of the electronic device.

28. The method of claim 27, further comprising setting the weight values as part of a manufacturing process of the electronic device.

29. The method of claim 27, further comprising setting the weight values for the weighted classifier function by minimizing a cost function using the recorded acceleration values.

30. The method of claim 29, wherein the cost function includes a logistic function.

31. The method of claim 29, wherein the acceleration values for the actual falls are weighted more heavily than the acceleration values for the false falls when minimizing the cost function to improve an accuracy of actual fall determination over an accuracy of false fall determination by the electronic device.
